(19) United States
(12) Patent Application Publication
(10) Pub. No.: US 2026/0185817 A1
(43) Pub. Date: Jul. 2, 2026

(54) METROLOGY SYSTEM UTILIZING MULTIPLE MEASUREMENTS

(71) Applicant: Mitutoyo Corporation, Kanagawa-ken (JP)

(72) Inventors: Christopher Richard HAMNER, Kirkland, WA (US); Zachary William FOX, Kenmore, WA (US); Ted Staton COOK, Kirkland, WA (US); Nick HARTMANN, Kirkland, WA (US); Pavel Ivanovich NAGORNYKH, Kirkland, WA (US)

(21) Appl. No.: 19/005,453

(22) Filed: Dec. 30, 2024

(51) Int. Cl. G01B 9/02091; G01B 11/24

(52) U.S. Cl. CPC G01B 9/02091; G01B 11/2441

(57) ABSTRACT

A metrology system includes: a light portion that outputs light; a branching portion; and a detector and processing portion. The branching portion branches the light as reference light along a reference optical path and as measurement light along a measurement optical path to be reflected by a workpiece that is to be measured. The detector and processing portion is configured to: receive combined light comprising the reference light and the measurement light; and convert the combined light into a combined light electrical signal. The detector and processing portion includes: an analog to digital converter; and a sample and hold portion. The sample and hold portion includes at least a first sample and hold circuit and a second sample and hold circuit, and is coupled to sample the combined light electrical signal (e.g., at respective first and second sample rates) and to provide outputs to the analog to digital converter.

### BACKGROUND

### Technical Field

This disclosure relates to precision metrology, and more particularly to precision workpiece surface measurement devices and systems.

### Description of the Related Art

Quality control of objects (e.g., workpieces) that include specific surface profiles (e.g., produced by molding and/or machining, or the like), is becoming increasingly demanding in terms of throughput, measurement resolution, and accuracy. Ideally, such workpieces should be measured/inspected to ensure proper dimensions, function, etc. However, very precise measurement tolerances (e.g., in some instances micron level or finer) may be required in order to confirm a workpiece surface with desired characteristics for some applications.

Various precision metrology systems may be used for workpiece surface measurements and inspection. For example, in some instances a metrology system that performs such operations may utilize a type of optical coherence tomography (OCT), such as frequency-modulated continuous wave (FMCW) technology, which can determine a distance to a target (e.g., to a point on a workpiece surface, for which distances to multiple points on a workpiece surface may be determined as part of measurement operations for the workpiece surface). An important part of such systems and/or other comparable measurement systems is the effective measurement range. Configurations that may improve or otherwise enhance such metrology systems (e.g., for measuring and inspecting surfaces of workpieces, etc.) would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to one aspect, a metrology system is provided, which includes: a light portion that outputs light; a branching portion; and a detector and processing portion. The branching portion branches a part of the light output from the light portion as reference light that is directed along a reference optical path, and branches at least a part of the remaining light as measurement light that is directed along a measurement optical path to be reflected by a workpiece that is to be measured. The detector and processing portion is configured to: receive combined light comprising reference light from the reference optical path and measurement light from the measurement optical path that is reflected by the workpiece; and convert the combined light into a combined light electrical signal. The detector and processing portion includes: an analog to digital converter; and a sample and hold portion. The sample and hold portion includes at least a first sample and hold circuit and a second sample and hold circuit, wherein the sample and hold portion is coupled to provide outputs to the analog to digital converter.

According to another aspect, a method for operating a metrology system is provided. The method includes:
receiving combined light comprising reference light from the reference optical path and measurement light from the measurement optical path that is reflected by the workpiece;
converting the combined light into a combined light electrical signal;
utilizing a first sample and hold circuit to sample the combined light electrical signal at a first sample rate and provide corresponding first outputs to an analog to digital converter; and
utilizing a second sample and hold circuit to sample the combined light electrical signal at a second sample rate that is lower than the first sample rate and provide corresponding second outputs to the analog to digital converter.

According to yet another aspect, a metrology system is provided which is configured to: receive combined light comprising reference light from the reference optical path and measurement light from the measurement optical path that is reflected by the workpiece; convert the combined light into a combined light electrical signal; utilize the first sample and hold circuit to sample the combined light electrical signal at a first sample rate and provide corresponding first outputs to the analog to digital converter; and utilize the second sample and hold circuit to sample the combined light electrical signal at a second sample rate that is lower than the first sample rate and provide corresponding second outputs to the analog to digital converter.

### BRIEF DESCRIPTION OF THE DRAWINGS

FIG. 1 is a block diagram of a metrology system including an interferometer portion and a circuitry portion;

FIG. 2 is a block diagram illustrating a first implementation of an interferometer portion as may be included in a metrology system such as that of FIG. 1;

FIG. 3 is a block diagram illustrating a second implementation of an interferometer portion as may be included in a metrology system such as that of FIG. 1;

FIG. 4 is a block diagram illustrating an implementation of a circuitry portion as may be included in a metrology system such as that of FIG. 1;

FIGS. 5A-5D are diagrams illustrating certain operating principles of a metrology system such as that of FIG. 1 and in which a measurement optical path length is longer than a reference optical path length;

FIGS. 6A-6D are diagrams illustrating certain operating principles of a metrology system such as that of FIG. 1 and in which a reference optical path length is longer than a measurement optical path length;

FIGS. 7A and 7B are diagrams illustrating a first implementation of a sample and hold portion and corresponding signal timings;

FIGS. 8A and 8B are diagrams illustrating a second implementation of a sample and hold portion and corresponding signal timings;

FIGS. 9A and 9B are diagrams illustrating a third implementation of a sample and hold portion and corresponding signal timings; and

FIG. 10 is a flow diagram illustrating an exemplary implementation of a routine for operating a metrology system.

### DETAILED DESCRIPTION

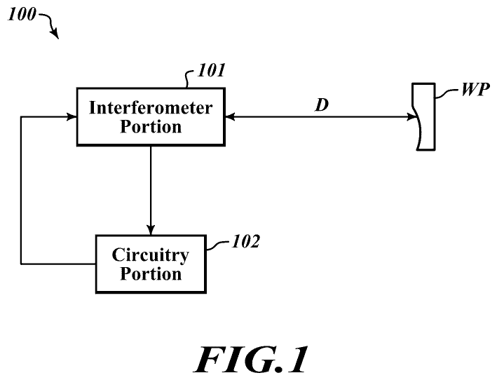

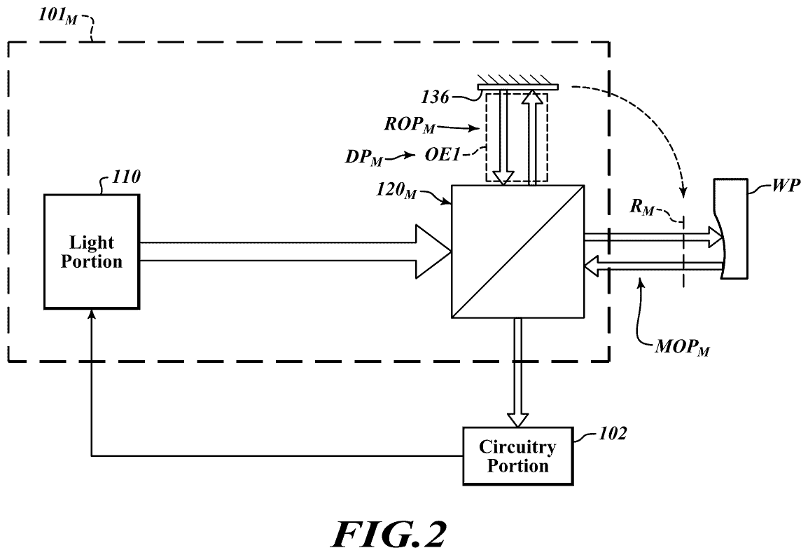

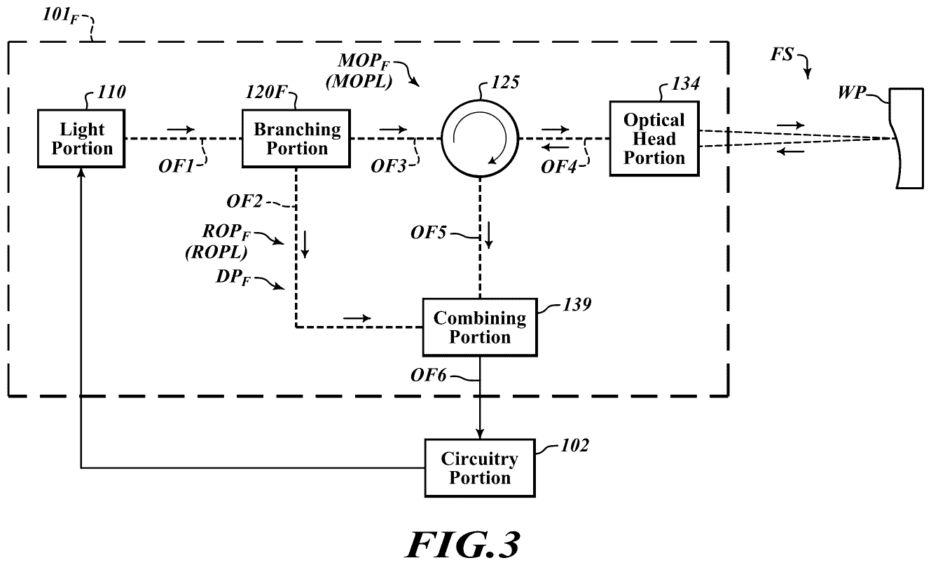

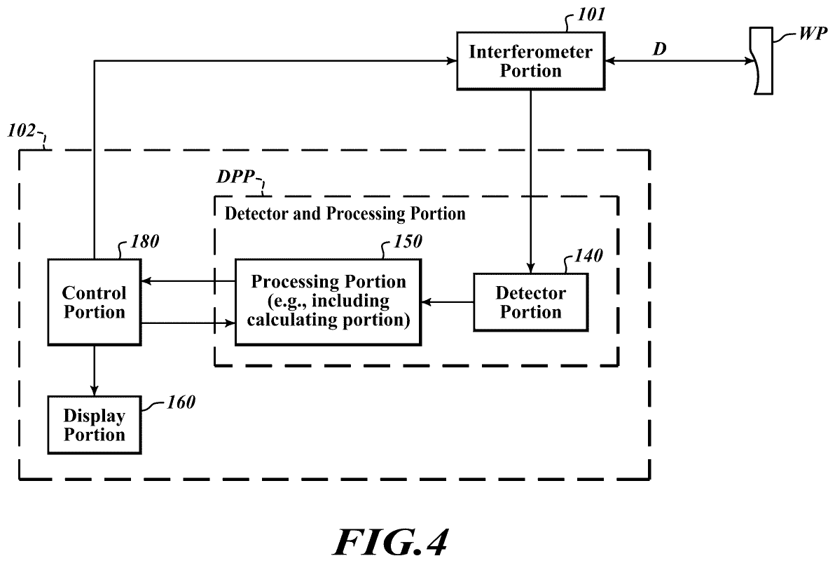

FIG. 1 is a block diagram showing a metrology system 100 together with a workpiece WP to be measured. As shown in FIG. 1, the metrology system 100 includes an interferometer portion 101 and a circuitry portion 102. The metrology system utilizes optical coherence tomography (OCT) techniques, such as frequency-modulated continuous wave (FMCW) techniques, as will be described in more detail below. Certain implementations of the interferometer portion 101 will be described in more detail below with respect to FIGS. 2 and 3. An implementation of the circuitry portion 102 will be described in more detail below with respect to FIG. 4.

In various implementations, the metrology system 100 is configured to determine a distance D to a workpiece. More specifically, the metrology system 100 optically measures a distance between the metrology system 100 and the workpiece WP. The metrology system 100 may also measure a three-dimensional shape and/or surface characteristics of the workpiece WP (e.g., by scanning the position of light irradiated on the workpiece WP, such as for measuring different points on a surface of the workpiece WP).

FIG. 2 is a block diagram illustrating a first implementation of an interferometer portion 101_{M} as may be included in a metrology system 100 such as that of FIG. 1. As shown in FIG. 2, the interferometer portion 101_{M} includes a light portion 110, a branching portion 120_{M} and a reference mirror 136. As will be described in more detail below, the interferometer portion 101_{M} directs light toward a workpiece WP (e.g., for measuring a distance to the workpiece WP).

In various implementations, the light portion 110 comprises a laser resonator and outputs laser light (e.g., the light portion 110 in FIGS. 2 and 3 may in some implementations also or alternatively be referenced as a laser portion 110). The light portion 110 may output, for example, frequency-modulated laser light. The light portion 110 may have a frequency shifter provided in the resonator and may output a laser for which the oscillation frequency changes linearly over time. In various implementations, the light portion 110 may comprise a frequency-shifted feedback laser.

The branching portion 120_{M} splits a portion of the light output by the light portion 110 as reference light and at least a portion of the remaining light as measurement light. As will be described in more detail below, the reference light is directed along a reference optical path ROP_{M} and the measurement light is directed along a measurement optical path MOP_{M}. In various implementations, the branching portion 120_{M} may comprise a splitter component (e.g., a beamsplitter, etc.) In various implementations, the splitter component may have a designated split ratio (e.g., 1:1, such that an approximately equal amount of light may be directed along each of the reference optical path ROP_{M} and the measurement optical path MOP_{M}).

In the reference optical path ROP_{M}, reference light branched from the branching portion 120_{M} is irradiated toward the reference mirror 136, which reflects the reference light back toward the branching portion 120_{M}. In the measurement optical path MOP_{M}, measurement light branched from the branching portion 120_{M} is irradiated toward the workpiece WP. Measurement light reflected from the workpiece WP is received back at the branching portion 120_{M}. In various implementations, a distance between at least part of the branching portion 120_{M} and the workpiece WP may be set as a distance D to be measured by the metrology system 100.

The branching portion 120_{M} combines the reflected measurement light with the reference light reflected by the reference mirror 136. In this way, FIG. 2 shows an example in which the branching portion 120_{M} also functions as a combining portion (e.g., for which in some implementations the branching portion may also or alternatively be referenced as a branching and combining portion 120_{M} or simply a combining portion 120_{M}). The branching portion 120_{M} outputs the combined light (e.g., including the reference light and the measurement light) to the circuitry portion 102 (e.g., to a detector portion 140 in the circuitry portion 102, as will be described in more detail below with respect to FIG. 4).

In various implementations, the reference optical path ROP_{M} may have a reference optical path length (e.g., as including the travel of the reference light to and from the reference mirror 136). Similarly, the measurement optical path MOP_{M} may have a measurement optical path length (e.g., as including the travel of the measurement light to and from the workpiece WP). In general, there may be a difference between the reference optical path length and the measurement optical path length. In the example of FIG. 2, a reference marker RM is provided which indicates a representation of the length of the reference optical path ROP_{M}, as shown in relation to the measurement optical path MOP_{M}. In this example, the measurement optical path MOP_{M} is indicated to have a greater length than the reference optical path ROP_{M}. In an alternative condition in which the reference optical path ROP_{M} had a greater length than the measurement optical path MOP_{M}, the measured surface of the workpiece WP would be shown before the reference marker RM (i.e., to the left of the reference marker RM in FIG. 2). As will be described in more detail below, the circuitry portion 102 may be configured to receive the combined light (i.e., comprising the combined reference light and measurement light), and to produce an output (e.g., which indicates a distance to the workpiece, and which correspondingly indicates a difference between the reference optical path length and the measurement optical path length).

In various implementations, an optical path length difference between the reference optical path length and the measurement optical path length may correspond to a propagation difference between the reference light and the measurement light, for which a propagation delay corresponding to the optical path length difference occurs in the reference light and the measurement light. As will be described in more detail below, by determining a signal that corresponds to the propagation delay (e.g., as determined utilizing the circuitry portion 102), a distance to the workpiece WP may be determined. More specifically, as noted above the measurement optical path length is a result of the distance to the workpiece (e.g., for which the measurement optical path length will be larger for longer distances to the workpiece, and will be smaller for shorter distances to the workpiece). Correspondingly, the propagation delay (e.g., which corresponds to a difference between the measurement optical path length and the known fixed reference optical path length) will be different for different distances to the workpiece. As will be described in more detail below, such relationships may be utilized for determining a measurement distance to a workpiece (e.g., in accordance with a determined signal that corresponds to the propagation delay and which correspondingly indicates an optical path length difference which indicates a measurement distance to the workpiece).

In various implementations, the interferometer portion 101_{M} of the metrology system may include a dispersion portion DP_{M}. In the example of FIG. 2, the dispersion portion DP_{M} is included in the reference optical path ROP_{M}, although in certain alternative implementations the dispersion portion may be included in the measurement optical path MOP_{F}. In the illustrated example, the dispersion portion DP_{M} comprises a high dispersion optical element OE1. In various implementations, the optical element OE1 may be at least semi-transparent for which light (e.g., reference light in the illustrated example) may pass through the optical element OE1, with the optical element OE1 causing dispersion of the light. In various implementations, an imbalanced dispersion between the reference optical path and the measurement optical path results at least in part from the dispersion portion (e.g., as may be utilized as part of the process for determining a measurement distance to the workpiece WP).

FIG. 3 is a block diagram illustrating a second implementation of an interferometer portion 101_{F} as may be included in a metrology system 100 such as that of FIG. 1. As shown in FIG. 3, the interferometer portion 101_{F} includes a light portion 110, a branching portion 120_{F}, a circulator portion 125, an optical head portion 134 and a combining portion 139. Optical fibers OF1-OF6 are shown to connect the different portions for providing light to and/or from the different portions. More specifically, the light portion 110 is coupled to the branching portion 120_{F} by an optical fiber OF1. The branching portion 120_{F} is coupled to the combining portion 139 by an optical fiber OF2, and is coupled to the circulator portion 125 by an optical fiber OF3. The circulator portion 125 is coupled to the optical head portion 134 by an optical fiber OF4, and is coupled to the combining portion 139 by an optical fiber OF5. The combining portion 139 is coupled to the circuitry portion 102 by an optical fiber OF6.

As will be described in more detail below, the interferometer portion 101_{F} directs light toward a workpiece WP (e.g., for measuring a distance to the workpiece WP). In various implementations, the metrology system may optically measure a distance between the interferometer portion 101_{F} and the workpiece WP (e.g., and in various implementations may also measure a three-dimensional shape and/or surface characteristics of the workpiece WP, such as by scanning the position of light irradiated on the workpiece WP, such as for measuring different points on a surface of the workpiece WP).

The branching portion 120_{F} branches the light output from the light portion 110, with part of the light as reference light and at least some of the remaining light as measurement light. The branching portion 120_{F} is, for example, a fiber optic splitter (e.g., as may also or alternatively be referenced as a fiber optic coupler). In the example of FIG. 3, the branching portion 120_{F} supplies the measurement light to the circulator portion 125, and supplies the reference light to the combining portion 139.

The circulator portion 125 has a plurality of input/output ports. For example, the circulator portion 125 inputs a light from one port and outputs the light from the next port, and inputs a light from the next port and outputs the light from the port after next. FIG. 3 shows an example in which the circulator portion 125 has three input/output ports. In this case, the circulator portion 125 outputs the measurement light supplied from the branching portion 120_{F} to the optical head portion 134. Also, the circulator portion 125 outputs a light input from the optical head portion 134 (i.e., as reflected from the workpiece WP) to the combining portion 139.

The optical head portion 134 provides/radiates/directs the light input from the circulator portion 125 toward the workpiece WP. The optical head portion 134 includes, for example, a collimator lens. In this case, the optical head portion 134 first adjusts the light input from the circulator portion 125 via the optical fiber OF4 into a beam shape using the collimator lens, and then outputs the light.

Also, the optical head portion 134 receives a reflected light of the measurement light radiated onto the workpiece WP. The optical head portion 134 focuses the received reflected light onto the optical fiber OF4 with a collimator lens and supplies it to the circulator portion 125. In this case, the optical head portion 134 may include one common collimator lens, and the collimator lens may irradiate the workpiece WP with the measurement light, and may receive the reflected light from the workpiece WP. In various implementations, a distance between at least part of the optical head portion 134 and the workpiece WP may be defined as a distance D (e.g., which may in some implementations be characterized as a measurement distance D).

Alternatively, the optical head portion 134 may include a focusing lens. In this case, the optical head portion 134 focuses the light input from the circulator portion 125 via the optical fiber OF4 on the surface of the workpiece WP. The optical head portion 134 receives at least a part of the reflected light reflected from the surface of the workpiece WP. The optical head portion 134 focuses the received reflected light onto the optical fiber OF4 using the focusing lens and supplies the light to the circulator portion 125. Also in this case, the optical head portion 134 may include one common focusing lens, and that focusing lens may irradiate the workpiece WP with the measurement light and receive the reflected light from the workpiece WP.

The combining portion 139 receives, from the circulator portion 125, the reflected light that is the measurement light radiated onto and reflected from the workpiece WP. Also, the combining portion 139 receives the reference light from the branching portion 120_{F}. The combining portion 139 combines/mixes the reflected measurement light and the reference light, and provides a corresponding output to the circuitry portion 102 (e.g., to a detector portion 140 in the circuitry portion 102, as will be described in more detail below with respect to FIG. 4). In various implementations, the combining portion 139 may be a fiber optic splitter (e.g., as may also be referenced as a fiber optic coupler and/or a fiber optic combiner).

For the reference light that travels along the reference optical path ROP_{F} (and as corresponding to a reference optical path length ROPL), the reference light travels from the branching portion 120_{F}, through the optical fiber OF2 to the combining portion 139. For the measurement light that travels along the measurement optical path MOP_{F} (and as corresponding to a measurement optical path length MOPL), the measurement light travels from the branching portion 120_{F}, through the optical fiber OF3, through the circulator portion 125, through the optical fiber OF4, through the optical head portion 134, through free space FS to the workpiece WP (e.g., according to a distance D from the optical head portion 134 to the workpiece WP), and is reflected by the workpiece WP to travel back through the free space FS to the optical head portion 134 (e.g., according to the distance D from the optical head portion 134 to the workpiece WP), through the optical head portion 134, through the optical fiber OF4, through the circulator portion 125, and through the optical fiber OF5 to the combining portion 139.

In various implementations, in which the oscillation frequency of the light output from the light portion 110 changes linearly with the passage of time (e.g., as may be characterized as a frequency sweep), a frequency difference, which is dependent on a propagation delay corresponding to the difference in the propagation distance, occurs between the oscillation frequency of the reference light and the oscillation frequency of the measurement light (e.g., as received at the combining portion 139). A beat signal may be generated as corresponding to such a frequency difference (e.g., as generated according to the combining of the reference light and the measurement light, such as by the combining portion 139 of FIG. 3 or the branching portion/combining portion 120_{M} of FIG. 2). As will be described in more detail below with respect to FIG. 4, a detector and processing portion DPP of the circuitry portion 102 may include a detector portion 140 and may provide a signal that corresponds to the difference in the propagation distance between the reference light and the measurement light.

In various implementations, as will be described in more detail below with respect to FIG. 4, the detector and processing portion DPP detects the difference in the propagation distance between the reference light and the measurement light by frequency-analyzing the beat signal that is generated. More specifically, in various implementations, the combined light (e.g., from the combining portion 139) is received by a detector portion 140 (e.g., of the detector and processing portion DPP), which may output a combined light electrical signal (e.g., which may be sinusoidal), which is digitized utilizing an analog to digital converter (e.g., as may in some implementations be included in a processing portion 150 of the detector and processing portion DPP). This digitized signal may then be analyzed through a fast Fourier transform algorithm (e.g., as performed by the processing portion 150, and which in various implementations may perform additional processing for determining a distance to a workpiece).

In various implementations, a display portion 160 of the circuitry portion 102 is controlled by a control portion 180 to display the analysis result of the detector and processing portion DPP (e.g., as may display or otherwise indicate a distance to a workpiece, etc.). In various implementations, the display portion 160 may include a display or the like and display the detection result, and the control portion 180 may store the analysis result in a storage unit or the like. In general, the metrology system may measure a distance between the interferometer portion 101 and the workpiece WP by analyzing a frequency difference between the reference light and the measurement light as reflected from the workpiece WP, as will be described in more detail below.

In various implementations, the interferometer portion 101_{F} of the metrology system may include a dispersion portion DP_{F}. In the example of FIG. 3, the dispersion portion DP_{F} is included in the reference optical path ROP_{F}, although in certain alternative implementations the dispersion portion may be included in the measurement optical path MOP_{F}. In the illustrated example, the dispersion portion DP_{F} comprises a high dispersion optical fiber OF2 (i.e., for which the optical fiber OF2 which couples the branching portion 120_{F} to the combining portion 139 as described above is a high dispersion optical fiber). In various implementations, the other optical path (e.g., the measurement optical path MOP_{F}) may include one or more lower dispersion optical fibers (e.g., lower in relation to the high dispersion optical fiber OF2 of the dispersion portion DP_{F}). For example, some or all of the optical fibers OF3, OF4 or OF5 may be relatively lower dispersion optical fibers. This may be contrasted with certain conventional configurations, in which optical fibers may be included in both optical paths with similar/matched (e.g., identical) dispersion characteristics. In various implementations, an imbalanced dispersion between the reference optical path and the measurement optical path results at least in part from the dispersion portion (e.g., as may be utilized as part of the process for determining a measurement distance to the workpiece WP).

Stated another way, in certain prior conventional configurations, matched optical fibers (e.g., with similar dispersion characteristics) in the reference and measurement optical paths have typically minimized cumulative unbalanced dispersion. Utilization of optical fibers with different dispersion characteristics in the two optical paths will result in an unbalanced dispersion (e.g., which in some instances may correspond to an increase in unbalanced dispersion). In such configurations, it is still desirable to match a baseline optical path length (OPL) for achieving the desired interference effects (e.g., as resulting from the combination of the reference and measurement light in the combining portion 139), but higher order phase can be added via dispersion.

In various implementations, an air gap (e.g., through free space FS, such as between the optical head portion 134 and the workpiece WP) may be utilized to deliver the measurement light to the workpiece WP. In some such configurations, it may be considered relatively more efficient to include relatively lower dispersion optical fiber(s) in the measurement optical path MOP (e.g., to enhance the dispersion mismatch created by the free space FS/air gap, such as relative to the reference optical path that may include a higher dispersion optical fiber). That being said, it will be appreciated that other configurations may also be utilized, with a primary goal in some such implementations being for the dispersion/optical fibers in the two optical paths to not be the same (e.g., having different dispersion characteristics), for which in general a greater dispersion mismatch may result in better disambiguation between signal peaks.

FIG. 4 is a block diagram illustrating an implementation of the circuitry portion 102 as may be included in a metrology system such as that of FIG. 1. As shown in FIG. 4, the circuitry portion 102 includes a detector and processing portion DPP (e.g., including a detector portion 140 and a processing portion 150), a display portion 160, and a control portion 180. In various implementations, the detector portion 140 of the detector and procession portion DPP receives/detects the combined reference and measurement light (e.g., as received from the branching portion 120_{M} of FIG. 2 or the combining portion 139 of FIG. 3) and converts the combined light into an electrical signal. In various implementations, the detector portion 140 detects a beat signal that is generated by combining and interfering the reference light and the measurement light. In various implementations, the detector portion 140 may have, for example, a photoelectric conversion element, and may convert the beat signal into an electrical signal. One example of the photoelectric conversion element is a photodiode. The detector and processing portion DPP may also have an analog-to-digital converter (ADC), which may convert/digitize the beat signal converted into an electrical signal into a digital signal.

As described above, in various implementations the oscillation frequency of the light output by the light portion 110 changes linearly over time. Therefore, a frequency difference occurs between the oscillation frequency of the reference light and the oscillation frequency of the measurement light according to the propagation delay. A beat signal is generated as corresponding to this frequency difference.

The processing portion 150 (e.g., including a calculation portion) analyzes the detected electrical signal to calculate the distance D to the workpiece WP. The processing portion 150 analyzes the frequency at which the beat signal is generated, for example, by using frequency conversion such as FFT. Then, the processing portion 150 calculates the optical path length difference corresponding to the frequency of the beat signal.

In various implementations, the control portion 180 receives the output from the processing portion 150 of the detector and processing portion DPP, and controls the display portion 160 to display the analysis results of the processing portion 150. The display portion 160 may have a display or the like and display the detection results. The display portion 160 may also receive instructions from a user. In various implementations, the control portion 180 may be configured to control certain operations of the light portion 110, the display portion 160, and/or the detector and processing portion DPP. In various implementations, the control portion 180 may control the light portion 110 to output the light to the branching portion 120 (e.g., of FIG. 2 or FIG. 3). In general, it is noted that the metrology system 100 including the interferometer portion 101 and the circuitry portion 102 is capable of measuring a distance between the metrology system 100 and the workpiece WP (e.g., by analyzing the frequency difference between the measurement light reflected by the workpiece WP and the reference light).

As noted above, in various implementations, the interferometer portion 101 (e.g., the interferometer portion 101_{M} of FIG. 2 or 101_{F} of FIG. 3) of the metrology system may include a dispersion portion DP (e.g., the dispersion portion DP_{M} of FIG. 2 or DP_{F} of FIG. 3). An imbalanced dispersion between a reference optical path ROP and a measurement optical path MOP may result at least in part from the dispersion portion. More specifically, the dispersion portion DP may result in a dispersion of the light in the reference optical path ROP that is different than a dispersion of the light in the measurement optical path MOP, as corresponding to the imbalanced dispersion between the reference optical path ROP and the measurement optical path MOP (e.g., as may be utilized as part of the process for determining a measurement distance to the workpiece WP).

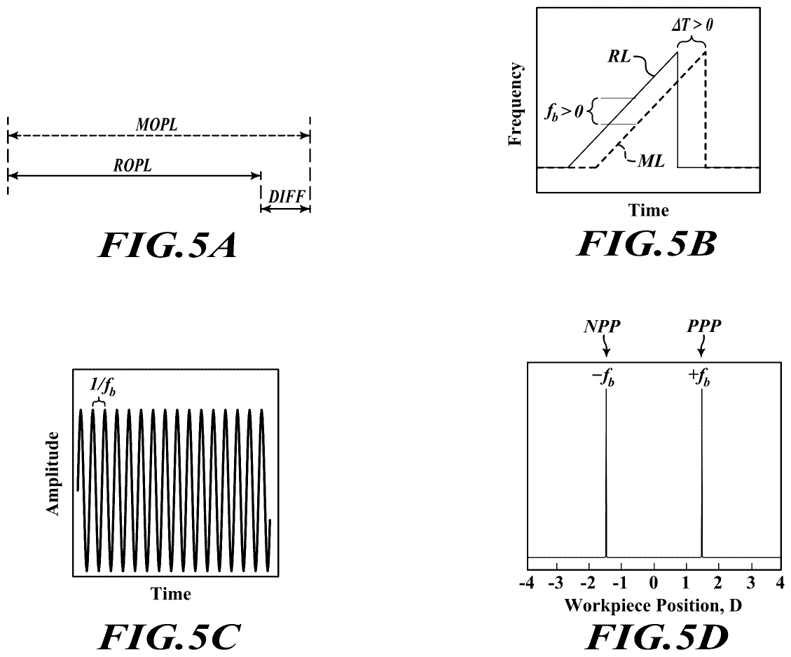

FIGS. 5A-5D are diagrams illustrating certain operating principles of a metrology system such as that of FIG. 1. As noted above, in various implementations the metrology system, including the light portion 110, is operated according to optical coherence tomography (OCT), such as frequency-modulated continuous wave (FMCW), which in some implementations may also be referenced as swept source optical coherence tomography (SS-OCT). FIG. 5A illustrates a condition in which a measurement distance (e.g., to a workpiece) is such that a measurement optical path length MOPL is longer than a reference optical path length ROPL. An optical path length difference DIFF is shown which corresponds to the difference between the optical path lengths. For example, where MOPL is 1.5 mm longer than ROPL, MOPL may correspond to a position of 1.5 mm in a range of −4.0 mm to +4.0 mm, for which distance D from the interferometer portion 101 (see FIG. 4) might be +5.5 mm, which spans from the −4.0 mm end of the negative range to +1.5 mm in the positive range (e.g., in a configuration where the range starts at an edge of the interferometer portion 101).

FIG. 5B is a graph illustrating changing frequencies versus time, with a dotted line signal corresponding to the measurement light ML, and a solid line signal corresponding to the reference light RL (e.g., as received at a combining portion, such as the combining portion 139). The shape of each signal is in accordance with the swept frequency of the light portion 110 (e.g., where the frequency of each signal increases linearly over time, up to a maximum at which point the frequency returns to the baseline level, after which the process may repeat during future time periods). A time delay ΔT between the signals is shown to be greater than 0, as corresponding to the propagation delay (e.g., due to the measurement optical path length MOPL being longer than the reference optical path length ROPL). A beat frequency f_{b} is also shown to correspondingly be greater than zero, and as corresponding to a difference in frequency between the two signals at a given time, as illustrated in FIG. 5B.

FIG. 5C is a graph of a combined signal (e.g., from the combining portion), for which the amplitude is indicated to oscillate over time. Due to the swept frequency of the light portion 110, the time delay (e.g., as illustrated in FIG. 5B) is encoded in the beat frequency f_{b} of the signal of FIG. 5C, when the reference light and the measurement light are combined (e.g., by the combining portion). In various implementations, the beat frequency may be detected as a function of time (e.g., by the detector portion 140 of the detector and processing portion DPP). In various implementations, a Fourier transform (e.g., as utilized by the processing portion 150) can evaluate the time domain data and extract any frequency information. Since the rate of change in the frequency (i.e., the slope of the frequency sweep) is known, the frequency information may be mapped to distance traveled by the light (e.g., as indicated in FIG. 5D, which shows signal peaks as corresponding to different workpiece distances/positions D).

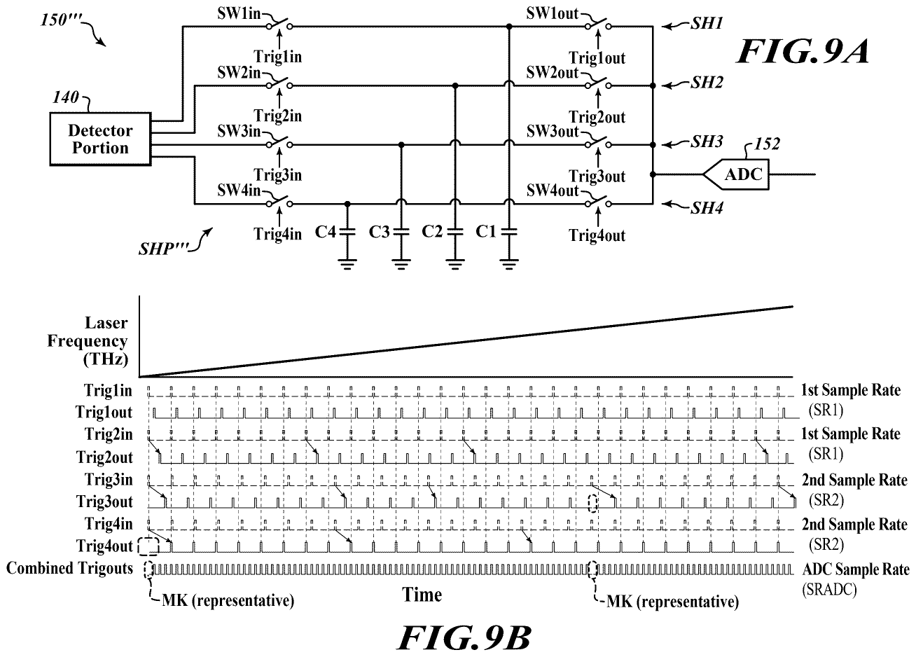

In further regard to FIG. 5D (i.e., for which the x-axis extends over a range from −4.0 mm to +4.0 mm), it is noted that the Fourier transform used to convert frequency space to distance produces + and − conjugate peak pairs (i.e., as corresponding to a positive position peak PPP and a negative position peak NPP, and as corresponding to a positive beat frequency +f_{b}, and a negative beat frequency −f_{b}, respectively). In general, standard processing for such systems has typically ignored the negative component (e.g., for which the measurement optical path length MOPL is always assumed/configured to be greater than the reference optical path length ROPL). In such systems, collecting data in the negative distance range has been considered undesirable due to the ambiguity in the signal peaks (i.e., in regard to which signal peak corresponds to the current measurement). In such systems, this has effectively reduced the usable distance range by approximately ½ (e.g., in the present example, utilizing only a 4 mm distance range as corresponding to the positive signal range from 0 to 4 mm, as opposed to the full 8 mm distance range as would correspond to the combination of the negative and positive distance ranges from −4.0 mm to +4.0 mm). In various implementations, in order to address such issues, the metrology system may include a dispersion portion (e.g., which enables disambiguation between the signal peaks). In various implementations, other techniques may alternatively be utilized for achieving such disambiguation (e.g., such as quadrature processing techniques, as will be described in more detail below with respect to FIGS. 9A and 9B).

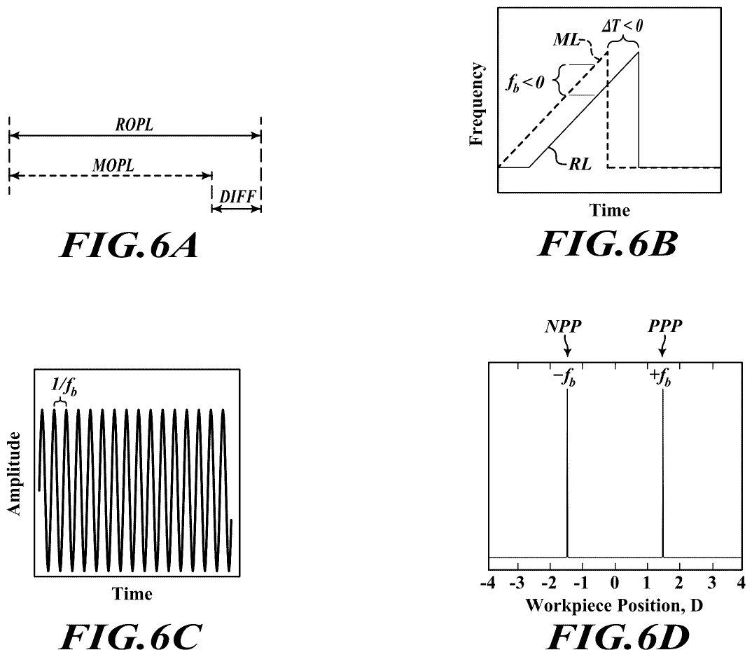

FIGS. 6A-6D are diagrams similar to the diagrams of FIGS. 5A-5D, respectively, except as corresponding to a reversed condition (i.e., with respect to the lengths MOPL and ROPL). More specifically, FIG. 6A illustrates a condition in which a measurement distance (e.g., to a workpiece) is such that a measurement optical path length MOPL is shorter than a reference optical path length ROPL. An optical path length difference DIFF is shown which corresponds to the difference between the optical path lengths (e.g., for which as a simplified example, the magnitude of the optical path length difference DIFF of FIG. 6A may be the same as the magnitude of the optical path length difference DIFF of FIG. 5A). For example, where MOPL is 1.5 mm shorter than ROPL, MOPL may correspond to a position of −1.5 mm in a range of −4.0 mm to +4.0mm, for which distance D from the interferometer portion 101 (see FIG. 4) might be +2.5 mm, which spans from the −4.0 mm end of the negative range to −1.5 mm in the negative range (e.g., in a configuration where the range starts at an edge of the interferometer portion 101).

In FIG. 6B (i.e., which is similar to FIG. 5B except with reversed relative signal positions), a dotted line signal corresponds to the measurement light ML, and a solid line signal corresponds to the reference light RL (e.g., as received at a combining portion). A time delay ΔT between the signals is shown to be less than 0, as corresponding to the propagation delay (e.g., due to the measurement optical path length MOPL being shorter than the reference optical path length ROPL). A beat frequency f_{b} is also shown to correspondingly be less than zero, and as corresponding to a difference in frequency between the two signals at a given time, as illustrated in FIG. 6B.

In FIG. 6C, the time delay (e.g., as illustrated in FIG. 6B) is encoded in the beat frequency f_{b} of the signal of FIG. 6C, when the reference light and the measurement light are combined (e.g., by the combining portion). In various implementations, similar to the process described above with respect to FIGS. 5C and 5D, the beat frequency may be detected as a function of time (e.g., by the detector portion 140 of the detector and processing portion DPP). The frequency information may be mapped to distance traveled by the light (e.g., as indicated in FIG. 6D, which shows signal peaks as corresponding to different workpiece distances/positions D).

In further regard to FIG. 6D, it is noted that the Fourier transform used to convert frequency space to distance produces + and − conjugate peak pairs (i.e., as corresponding to a positive position peak PPP and a negative position peak NPP, and as corresponding to a positive beat frequency +f_{b}, and a negative beat frequency −f_{b}, respectively). The produced positive and negative signal peaks are noted to basically be identical to those of FIG. 5B. Due at least in part to the corresponding ambiguity between the signal peaks, as noted above (i.e., with respect to standard processing in certain previous systems), collecting data in the negative distance range has been considered undesirable (i.e., in regard to ambiguity as to which signal peak corresponds to the current measurement). More specifically, if a measurement process is performed which results in the positive position peak PPP and the negative position peak NPP at the indicated positions (i.e., as corresponding to +1.5 mm and −1.5 mm, respectively, as shown in FIGS. 5D and 6D), it may be unclear if the measurement corresponds to the positive position peak PPP at the +1.5 mm position or the negative position peak NPP at the −1.5 mm position (e.g., as corresponding to the difference between the measurement optical path length MOPL and the reference optical path length ROPL). As noted above, in various implementations, in order to address such issues, the metrology system may include a dispersion portion (e.g., which enables disambiguation between the signal peaks) In various implementations, other techniques may alternatively be utilized for achieving such disambiguation (e.g., such as quadrature processing techniques, as described in more detail below with respect to FIGS. 9A and 9B).

As noted above with respect to FIGS. 2, 3, 5A-5D and 6A-6D, in various implementations the metrology system may include a dispersion portion (e.g., which enables disambiguation between the signal peaks). Techniques and configurations utilizing such a dispersion portion are described in more detail in U.S. Patent Application entitled “METROLOGY SYSTEM UTILIZING FULL RANGE DETECTION” (Attorney Docket No. 660051.578, U.S. patent application Ser. No. 19/005,052, filed on Dec. 30, 2024), which is commonly assigned and filed concurrently herewith and is hereby incorporated herein by reference in its entirety.

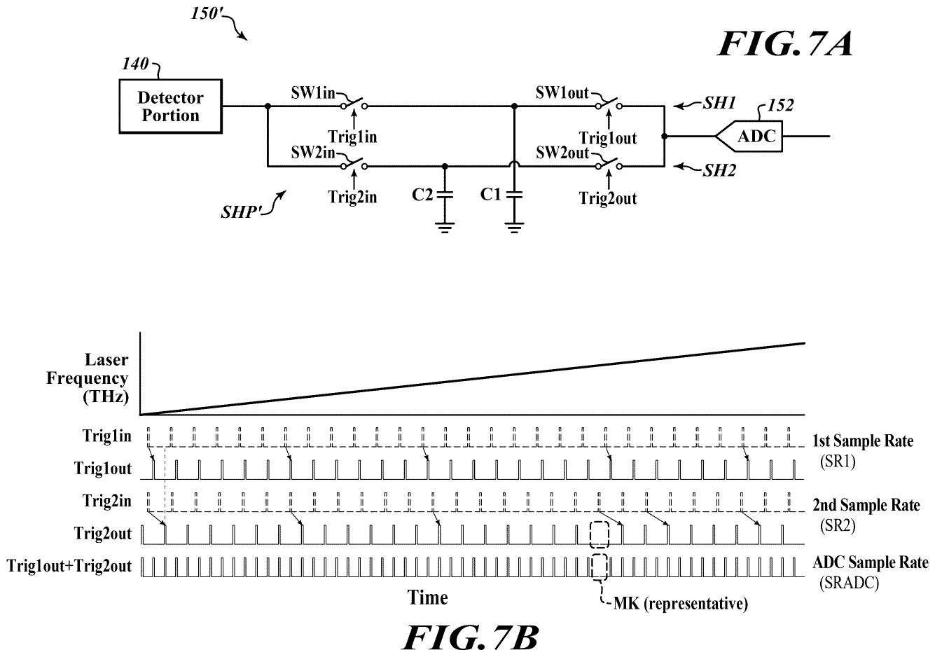

As will be described in more detail below with respect to FIGS. 7A-10, as part of the processing of a metrology system such as that described herein, the combined light (e.g., from the combining portion 139) is received by the detector portion 140, which may output a combined light electrical signal (e.g., which may be sinusoidal), which is digitized utilizing an analog to digital converter (e.g., as may in some implementations be included in the processing portion 150). This digitized signal may then be analyzed through a fast Fourier transform algorithm (e.g., as performed by the processing portion 150). FIGS. 7A-9B illustrate certain implementations of sample and hold portions SHP (e.g., which may be included between the detector portion 140 and the analog to digital converter, as will be described in more detail below).

As some general principles, it is noted that in certain traditional systems, an FMCW absolute (ABS) range has been limited by the minimum frequency step size in the sample (dF). This requires that the dynamic range (e.g., max distance, relative to multi-target resolution) is equal to the number of samples per sweep (e.g., macro 10 m/10 um requires 1 million samples per sweep). With large ranges, the beat frequency may also become too high for easy digital conversion (e.g., in relation to analog to digital converter and processing speeds).

Beyond the traditional FMCW ABS range, there is ambiguity about the position up to an integer multiple of the ABS range. In accordance with principles as described herein, the range may be extended by the use of a second measurement (e.g., analogous to a second measurement track) with a slightly different period. In various implementations, the period that may be changed is of the FMCW ABS range.

In various implementations, two measurements may be performed with different sample frequency spacings dF₁ and dF₂ (e.g., as corresponding to different sample rates). Configurations utilizing different sample rates are described in more detail below with respect to FIGS. 7A-9B. In various implementations, it may be desirable to utilize the full Nyquist measurement range (+/− range) for such techniques. As described above, such can be achieved through certain techniques, such as inclusion of a dispersion portion, or alternatively quadrature detection of the beat signal may be utilized (e.g., in accordance with the implementation of FIGS. 9A and 9B, as will be described in more detail below).

In accordance with principles as described herein, and as will be described in more detail below, utilization of a low bandwidth analog to digital converter to acquire high bandwidth signals is achieved by including a high bandwidth sample and hold portion SHP in front of the analog to digital converter (e.g., as illustrated in the examples of FIGS. 7A, 8A and 9A, as will be described in more detail below). In general, the techniques as described herein may have various advantages, such as enabling measurement of longer ranges, requiring fewer samples and/or enabling utilization of slower electronics (e.g., such as a slower analog to digital converter as utilized in combination with the relatively faster sample and hold portion SHP).

FIGS. 7A and 7B are diagrams illustrating a first implementation of a sample and hold portion SHP′ and corresponding signal timings. As shown in FIG. 7A, a sample and hold portion SHP′ (e.g., as part of a processing portion 150′ of a detector and processing portion DPP) is coupled to a detector portion 140 (e.g., to receive signals from the detector portion 140, such as a combined light electrical signal from the detector portion 140). As will be described in more detail below, in various implementations the sample and hold portion SHP′ may be configured to sample a combined light electrical signal from the detector portion. The sample and hold portion SHP′ is coupled to provide outputs (e.g., samples) to an analog to digital converter 152 (e.g., as part of a processing portion 150′ of a detector and processing portion DPP). In accordance with principles as described herein, in various implementations a processing portion may further be configured to perform a fast Fourier transform on (i.e., for analyzing) each digitized signal to determine at least one peak that corresponds to a beat frequency. In addition, a distance to a workpiece may be determined based at least in part on a determined peak which corresponds to a beat frequency.

As illustrated in FIG. 7A, the sample and hold portion SHP′ includes a first sample and hold circuit SH1 and a second sample and hold circuit SH2. The first and second sample and hold circuits SH1 and SH2 are coupled in parallel between the detector portion 140 and the analog to digital converter 152. The first sample and hold circuit SH1 includes a first input switch SW1in, a first capacitor C1, and a first output switch SW1out. The first input switch SW1in is coupled (e.g., on an input side) to the detector portion 140 and is coupled (e.g., on an output side) to the first capacitor C1. The first output switch SW1out is coupled (e.g., on an input side) to the first capacitor C1, and is coupled (e.g., on an output side) to the analog to digital converter 152. The operations of the sample and hold portion SHP′ (e.g., including control of the switches SW1in and SW1out by control signals Trig1in and Trig1out, respectively) will be described in more detail below with respect to FIG. 7B.

The second sample and hold circuit SH2 includes a second input switch SW2in, a second capacitor C2, and a second output switch SW2out. The second input switch SW2in is coupled (e.g., on an input side) to the detector portion 140 and is coupled (e.g., on an output side) to the second capacitor C2. The second output switch SW2out is coupled (e.g., on an input side) to the second capacitor C2, and is coupled (e.g., on an output side) to the analog to digital converter 152. The operations of the sample and hold portion SHP′ (e.g., including control of the switches SW2in and SW2out by control signals Trig2in and Trig2out, respectively) will be described in more detail below with respect to FIG. 7B.

FIG. 7B illustrates certain signals in relation to the operations of the sample and hold portion SHP′ of FIG. 7A. FIG. 7B shows signals versus time, for a laser frequency, control signals Trig1in, Trig1out, Trig2in and Trig2out, and a representative combined signal Trig1out+Trig2out. As described herein, the light that is output by the light portion (e.g., light portion 110) comprises laser light for which an oscillation frequency changes linearly over time (e.g., in accordance with a “chirped” laser, etc.), and for which in FIG. 7B the laser frequency is shown to increase linearly over time. This is noted to be similar to the plots in FIGS. 5B and 6B (i.e., for the reference light and the measurement light, which come from light from the light portion 110). The other signals of FIG. 7B as described below are noted to be provided during the time period when the laser frequency is increasing. Thus, in various implementations, as time increases, the signals may correspond to samplings when the laser frequency is at higher frequencies. As will be described in more detail below, the analog to digital conversions (e.g., the digitizing of the signals) are interlaced between the first and second sample and hold circuits SH1 and SH2.

The control signals Trig1in, Trig1out, Trig2in and Trig2out are utilized for controlling the switches SW1in, SW1out, SW2in and SW2out, respectively, of the sample and hold portion SHP′. The first input control signal Trig1in is shown to be provided according to a first sample rate SR1 for operating the first input switch SW1in, and the second input control signal Trig2in is shown to be provided according to a second sample rate SR2 for operating the second input switch SW2in. The second sample rate SR2 is noted to be lower than the first sample rate SR1, as will be described in more detail below.

As a more specific description of certain operations, in various implementations, the first input switch SW1in is operated (e.g., to be closed or otherwise placed in a conducting state) in accordance with the first input control signal Trig1in, to sample the output of the detector portion 140 (e.g., the combined light electrical signal) onto the first capacitor C1 (e.g., while the first output switch SW1out is in an open or otherwise non-conducting state, in accordance with the first output control signal Trig1out). More specifically, while the first input switch SW1in is closed or otherwise conducting, and the first output switch SW1out is open or otherwise non-conducting, the first capacitor C1 is charged to a level in accordance with the signal from the detector portion 140, and thus samples the signal (e.g., the combined light electrical signal) at that corresponding time.

Then, after the first input switch SW1in is operated (e.g., to be open or otherwise placed in a non-conducting state) in accordance with the first input control signal Trig1in, the output switch SW1out is operated (e.g., to be closed or otherwise placed in a conducting state) in accordance with the first output control signal Trig1out, to couple the first capacitor C1 (e.g., to provide the sample value that is stored on the first capacitor C1) to the input of the analog to digital converter 152 (e.g., which correspondingly operates to digitize the sample value stored on the first capacitor C1). By repeating this process (i.e., in accordance with the indicated transitions of the control signals Trig1in and Trig1out), the signal from the detector portion 140 (e.g., the combined light electrical signal) as sampled by the first sample and hold circuit SH1 may be digitized by the analog to digital converter 152.

It will be appreciated that similar operations may be performed with respect to the second sample and hold circuit SH2. As a brief summary, the switches SW2in and SW2out may be controlled, in accordance with the control signals Trig2in and Trig2out, to store samples on the capacitor C2, and then provide the samples to be digitized by the analog to digital converter 152. In accordance with this process (i.e., in accordance with the indicated transitions of the control signals Trig2in and Trig2out), the signal from the detector portion 140 (e.g., the combined light electrical signal) as sampled by the second sample and hold circuit SH2 may be digitized by the analog to digital converter 152.

As noted above, the second sample rate SR2 is lower than the first sample rate SR1. In the specific example of FIG. 7B, for the time period that is illustrated, in accordance with the first sample rate SR1, there are shown to be 29 cycles of the first input control signal Trig1in (e.g., corresponding to 29 instances of the first input control signal Trig1in cycling from low to high, and from high to low). In accordance with the second sample rate SR2, there are shown to be 28 cycles of the second input control signal Trig2in (e.g., corresponding to 28 instances of the second input control signal Trig2in cycling from low to high, and from high to low). As a specific numerical example, this may indicate a ratio of SR2/SR1=28/29=0.97. Some design considerations for having the relatively small differences between the first and second sample rates will be described in more detail below following the description of FIG. 9B.

As shown at the bottom of FIG. 7B, the analog to digital converter sample rate SRADC corresponds to the combination of the first and second output control signals Trig1out and Trig2out. In the illustrated example, the analog to digital converter sample rate SRADC is noted to be approximately 2× the first sample rate SR1. The timings of the first and second output control signals Trig1out and Trig2out are structured so that the analog to digital converter sample rate SRADC desirably occurs with samples at regularly spaced intervals (e.g., thus reducing the requirements on the analog to digital converter). It is noted that this occurs even though a similar combination of the first and second input control signals Trig1in and Trig2in would not be so structured, and would have varying spacings between the combination of control signals, including some intervals where the spacings would be very small, as could create significant processing burdens without the current circuit structure as illustrated and described herein.

In the present example, the desirable effect is achieved in part by having the second output control signal Trig2out structured to provide the regularly spaced contribution to the analog to digital converter sample rate SRADC, but not structured to exactly match the timings of the second input control signal Trig2in. For example, as contrasted with the first output control signal Trig1out which is shown to provide a transition shortly after each transition of the first input control signal Trig1in (e.g., as illustrated in part by some small example arrows between Trig1in and Trig1out indicating the sample and conversion timing relationships), the transitions of the second output control signal Trig2out occur at different spacings after the transitions of the second input control signal Trig2in (e.g., as illustrated in part by some small example arrows between Trig2in and Trig2out indicating the sample and conversion timing relationships). In certain implementations, this may occasionally result in a skipped analog to digital conversion, as illustrated in FIG. 7B by an empty box MK in the illustrated transitions for the second output control signal Trig2out and correspondingly in the combined Trig1out+Trig2out. In various implementations, this may also be characterized as corresponding to a duplicate sample due to a Vernier effect between the two sample rates.

As noted above, the output control signals Trig1out and Trig2out (e.g., as corresponding to the providing of the samples to the analog to digital converter 152) are structured so as to reduce the requirements on the analog to digital converter. As can be seen, the output signals to the analog to digital converter 152 (i.e., as indicated by the analog to digital converter sample rate SRADC at the bottom of FIG. 7B) are structured to be at specified intervals (i.e., with specified regular spacings between the transitions/samples), which reduces the requirements for the analog to digital converter. This may be contrasted to a configuration in which the sample and hold circuits were not present, and if the analog to digital converter was tasked with acquiring the data according to the first sample rate SR1 and the second sample rate SR2 by itself (e.g., for which there would not be regular spacings for the signals and some of the acquisition signals/timings for the second sample rate SR2 would be very close to some of the acquisition signals/timings for the first sample rate SR1, which would significantly increase the operating requirements for the analog to digital converter).

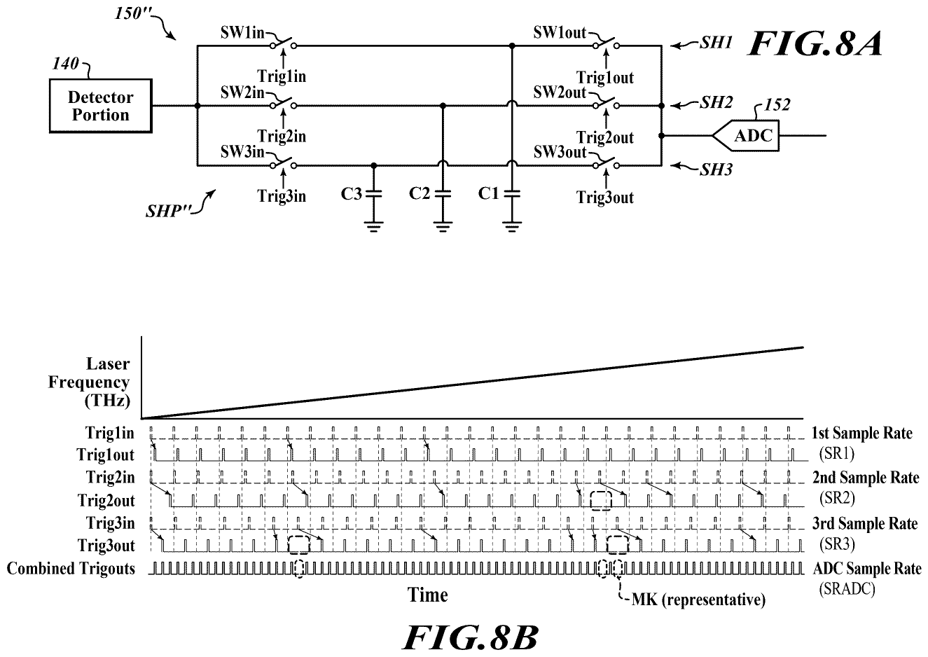

FIGS. 8A and 8B are diagrams illustrating a second implementation of a sample and hold portion SHP″ and corresponding signal timings. As shown in FIG. 8A, a sample and hold portion SHP″ (e.g., as part of a processing portion 150″ of a detector and processing portion DPP) is coupled to a detector portion 140 (e.g., to receive signals from the detector portion 140, such as a combined light electrical signal from the detector portion 140). As will be described in more detail below, in various implementations the sample and hold portion SHP″ may be configured to sample a combined light electrical signal from the detector portion. The sample and hold portion SHP″ is coupled to provide outputs (e.g., samples) to an analog to digital converter 152 (e.g., as part of a processing portion 150″ of a detector and processing portion DPP). In accordance with principles as described herein, in various implementations a processing portion may further be configured to perform a fast Fourier transform on (i.e., for analyzing) each digitized signal to determine at least one peak that corresponds to a beat frequency. In addition, a distance to a workpiece may be determined based at least in part on a determined peak which corresponds to a beat frequency.

As illustrated in FIG. 8A, the sample and hold portion SHP″ includes a first sample and hold circuit SH1, a second sample and hold circuit SH2, and a third sample and hold circuit SH3. The sample and hold circuits SH1, SH2 and SH3 are coupled in parallel between the detector portion 140 and the analog to digital converter 152. A primary difference of the sample and hold portion SHP″ of FIG. 8A as compared to the sample and hold portion SHP′ of FIG. 7A, is the addition of the third sample and hold circuit SH3. The description of the first and second sample and hold circuits SH1 and SH2 in the sample and hold portion SHP′ and corresponding operations as noted above will be understood to also apply to the first and second sample and hold circuits SH1 and SH2 of the sample and hold portion SHP″ of FIG. 8A, unless otherwise described below. Thus, at least part of the description below is primarily in relation to the differences corresponding to the additional sample and hold circuit SH3.

The third sample and hold circuit SH3 includes a third input switch SW3in, a third capacitor C3, and a third output switch SW3out. The third input switch SW3in is coupled (e.g., on an input side) to the detector portion 140 and is coupled (e.g., on an output side) to the third capacitor C3. The third output switch SW3out is coupled (e.g., on an input side) to the third capacitor C3, and is coupled (e.g., on an output side) to the analog to digital converter 152. The operations of the sample and hold portion SHP″ (e.g., including control of the switches SW3in and SW3out by control signals Trig3in and Trig3out, respectively) will be described in more detail below with respect to FIG. 8B.

FIG. 8B illustrates certain signals in relation to the operations of the sample and hold portion SHP″ of FIG. 8A. FIG. 8B shows signals versus time, for a laser frequency, control signals Trig1in, Trig1out, Trig2in, Trig2out, Trig3in and Trig3out and a representative combined signal for Combined Trigouts (i.e., including Trig1out+Trig2out+Trig3out). The control signals Trig1in, Trig1out, Trig2in and Trig2out have certain similarities to the control signals as described above with respect to FIG. 7B, and will be understood to have analogous functions, except as otherwise described below.

The laser frequency as shown in FIG. 8B is the same as and will be understood in accordance with the description of the laser frequency of FIG. 7B. As will be described in more detail below, the analog to digital conversions (e.g., the digitizing of the signals) are interlaced between the first, second and third sample and hold circuits SH1, SH2 and SH3. The control signals Trig1in, Trig1out, Trig2in, Trig2out, Trig3in and Trig3out are utilized for controlling the switches SW1in, SW1out, SW2in, SW2out, SW3in and SW3out, respectively, of the sample and hold portion SHP″. The first input control signal Trig1in is shown to be provided according to a first sample rate SR1 for operating the first input switch SW1in, the second input control signal Trig2in is shown to be provided according to a second sample rate SR2 for operating the second input switch SW2in, and the third input control signal Trig3in is shown to be provided according to a third sample rate SR3 for operating the third input switch SW3in. The second sample rate SR2 is noted to be lower than the first sample rate SR1, and the third sample rate SR3 is noted to be lower than the second sample rate SR2, as will be described in more detail below.

With respect to the more specific operations of the first and second sample and hold circuits SH1 and SH2 as described above with respect to FIG. 7B, it will be appreciated that similar operations may be performed with respect to the third sample and hold circuit SH3 of FIG. 8B. As a brief summary, the switches SW3in and SW3out may be controlled, in accordance with the control signals Trig3in and Trig3out, to store samples on the capacitor C3, and then provide the samples to be digitized by the analog to digital converter 152. In accordance with this process (i.e., in accordance with the indicated transitions of the control signals Trig3in and Trig3out), the signal from the detector portion 140 (e.g., the combined light electrical signal) as sampled by the third sample and hold circuit SH3 may be digitized by the analog to digital converter 152.

As noted above, the second sample rate SR2 is lower than the first sample rate SR1, and the third sample rate SR3 is lower than the second sample rate SR2. In the specific example of FIG. 8B, for the time period that is illustrated, in accordance with the first sample rate SR1, there are shown to be 29 cycles of the first input control signal Trig1in (e.g., corresponding to 29 instances of the first input control signal Trig1in cycling from low to high, and from high to low). In accordance with the second sample rate SR2, there are shown to be 28 cycles of the second input control signal Trig2in (e.g., corresponding to 28 instances of the second input control signal Trig2in cycling from low to high, and from high to low). As a specific numerical example, this may indicate a ratio of SR2/SR1=28/29=0.97. In accordance with the third sample rate SR3, there are shown to be 27 cycles of the third input control signal Trig3in (e.g., corresponding to 27 instances of the third input control signal Trig3in cycling from low to high, and from high to low). As some specific numerical examples, this may indicate a ratio of SR3/SR2=27/28=0.96, or SR3/SR1=27/29=0.93. Some design considerations for having the relatively small differences between the first, second and third sample rates will be described in more detail below following the description of FIG. 9B.

As shown at the bottom of FIG. 8B, the analog to digital converter sample rate SRADC corresponds to the combination of the first, second and third output control signals Trig1out, Trig2out and Trig3out. In the illustrated example, the analog to digital converter sample rate is noted to be approximately 3× the first sample rate SR1. The timings of the first, second and third output control signals Trig1out, Trig2out and Trig3out are structured so that the analog to digital converter sample rate SRADC desirably occurs with samples at regularly spaced intervals (e.g., thus reducing the requirements on the analog to digital converter). It is noted that this occurs even though a similar combination of the first, second and third input control signals Trig1in, Trig2in and Trig3in would not be so structured, and would have varying spacings between the combination of control signals, including some intervals where the spacings would be very small, as could create significant processing burdens without the current circuit structure as illustrated and described herein.

In the present example, the desirable effect is achieved in part by having the second and third output control signals Trig2out and Trig3out structured to provide the regularly spaced contribution to the analog to digital converter sample rate SRADC, but not structured to exactly match the timings of the corresponding second and third input control signals Trig2in and Trig3in. For example, as contrasted with the first output control signal Trig1out which is shown to provide a transition shortly after each transition of the first input control signal Trig1in (e.g., as illustrated in part by some small example arrows between Trig1in and Trig1out indicating the sample and conversion timing relationships), the transitions of the second output control signal Trig2out occur at different spacings after the transitions of the second input control signal Trig2in (e.g., as illustrated in part by some small example arrows between Trig2in and Trig2out indicating the sample and conversion timing relationships). Similarly, the transitions of the third output control signal Trig3out occur at different spacings after the transitions of the third input control signal Trig3in (e.g., as illustrated in part by some small example arrows between Trig3in and Trig3out indicating the sample and conversion timing relationships). In certain implementations, this may occasionally result in a skipped analog to digital conversion, as illustrated in FIG. 8B by empty boxes MK in the illustrated transitions for the second or third output control signals Trig2out or Trig3out, and correspondingly in the combined Trig1out+Trig2out+Trig3out. In various implementations, this may also be characterized as corresponding to duplicate samples due to a Vernier effect between the three sample rates.

As noted above, the output control signals Trig1out, Trig2out and Trig3out (e.g., as corresponding to the providing of the samples to the analog to digital converter 152) are structured so as to reduce the requirements on the analog to digital converter. As can be seen, the output signals to the analog to digital converter 152 (i.e., as indicated by the analog to digital converter sample rate SRADC at the bottom of FIG. 8B) are structured to be at specified intervals (i.e., with specified regular spacings between the transitions/samples), which reduces the requirements for the analog to digital converter. This may be contrasted to a configuration in which the sample and hold circuits were not present, and if the analog to digital converter was tasked with acquiring the data according to the first, second and third sample rates SR1, SR2 and SR3 by itself (e.g., for which there would not be regular spacings for the signals and some of the acquisition signals/timings between the sample rates would be very close to one another, which would significantly increase the operating requirements for the analog to digital converter).

FIGS. 9A and 9B are diagrams illustrating a third implementation of a sample and hold portion SHP′″ and corresponding signal timings. As will be described in more detail below, in various implementations, the sample and hold portion SHP′″ may be utilized for quadrature processing. In some such implementations, the quadrature processing may be utilized as an alternative to including a dispersion portion in the interferometer portion, and may enable similar disambiguation (e.g., of signal peaks, etc.) as noted above.

As shown in FIG. 9A, the sample and hold portion SHP′″ (e.g., as part of a processing portion 150′″ of a detector and processing portion DPP) is coupled to a detector portion 140 (e.g., to receive signals from the detector portion 140, such as a combined light electrical signal from the detector portion 140). As will be described in more detail below, in various implementations the sample and hold portion SHP′″ may be configured to sample a combined light electrical signal from the detector portion. The sample and hold portion SHP′″ is coupled to provide outputs (e.g., samples) to an analog to digital converter 152 (e.g., as part of a processing portion 150′″ of a detector and processing portion DPP). In accordance with principles as described herein, in various implementations a processing portion may further be configured to perform a fast Fourier transform on (i.e., for analyzing) each digitized signal to determine at least one peak that corresponds to a beat frequency. In addition, a distance to a workpiece may be determined based at least in part on a determined peak which corresponds to a beat frequency.

As illustrated in FIG. 9A, the sample and hold portion SHP′″ includes a first sample and hold circuit SH1, a second sample and hold circuit SH2, a third sample and hold circuit SH3, and a fourth sample and hold circuit SH4. The sample and hold circuits SH1, SH2, SH3 and SH4 are coupled between the detector portion 140 and the analog to digital converter 152. A primary difference of the sample and hold portion SHP′″ of FIG. 9A as compared to the sample and hold portion SHP′ of FIG. 7A, is the addition of the third and fourth sample and hold circuits SH3 and SH4, as well as the connections to the detector portion 140. In general, much of the description of the sample and hold circuits SH1 and SH2 in the sample and hold portion SHP′ and corresponding operations as noted above will be understood to also apply to the sample and hold circuits SH1, SH2, SH3 and SH4 of the sample and hold portion SHP′″ of FIG. 9A, unless otherwise described below. Thus, at least part of the description below is primarily in relation to the differences corresponding to the sample and hold portion SHP′″.

As one difference (e.g., in relation to the potential quadrature processing), the detector portion 140 may include multiple detectors (e.g., and with a phase shift in the quadrature signals as generated optically, prior to the detectors, which in some implementations may be photo detectors). In one implementation, the detector portion 140 may include first and second detectors (not shown), such as with the first and third sample and hold circuits SH1 and SH3 coupled to a first detector, and the second and fourth sample and hold circuits coupled to a second detector. As will be described in more detail below, in such a configuration, each pair of quadrature measurements (e.g., including a first pair corresponding to the first and second sample and hold circuits SH1 and SH2, and a second pair corresponding to the third and fourth sample and hold circuits SH3 and SH4) may occur at the same time. Thus, the outputs of the first and second detectors may be measured at a same time by the first and second sample and hold circuits SH1 and SH2, respectively, and then may be measured again at a same time by the third and fourth sample and hold circuits SH3 and SH4, respectively.

In the implementation of FIG. 9A, the first sample and hold circuit SH1 includes a first input switch SW1in, a first capacitor C1, and a first output switch SW1out. The first input switch SW1in is coupled (e.g., on an input side) to the detector portion 140 (e.g., to a first detector of the detector portion 140) and is coupled (e.g., on an output side) to the first capacitor C1. The first output switch SW1out is coupled (e.g., on an input side) to the first capacitor C1, and is coupled (e.g., on an output side) to the analog to digital converter 152. The operations of the sample and hold portion SHP′″ (e.g., including control of the switches SW1in and SW1out by control signals Trig1in and Trig1out, respectively) will be described in more detail below with respect to FIG. 9B.

The second sample and hold circuit SH2 includes a second input switch SW2in, a second capacitor C2, and a second output switch SW2out. The second input switch SW2in is coupled (e.g., on an input side) to the detector portion 140 (e.g., to a second detector of the detector portion 140) and is coupled (e.g., on an output side) to the second capacitor C2. The second output switch SW2out is coupled (e.g., on an input side) to the second capacitor C2, and is coupled (e.g., on an output side) to the analog to digital converter 152. The operations of the sample and hold portion SHP′″ (e.g., including control of the switches SW2in and SW2out by control signals Trig2in and Trig2out, respectively) will be described in more detail below with respect to FIG. 9B.

The third sample and hold circuit SH3 includes a third input switch SW3in, a third capacitor C3, and a third output switch SW3out. The third input switch SW3in is coupled (e.g., on an input side) to the detector portion 140 (e.g., to a first detector of the detector portion 140) and is coupled (e.g., on an output side) to the third capacitor C3. The third output switch SW3out is coupled (e.g., on an input side) to the third capacitor C3, and is coupled (e.g., on an output side) to the analog to digital converter 152. The operations of the sample and hold portion SHP′″ (e.g., including control of the switches SW3in and SW3out by control signals Trig3in and Trig3out, respectively) will be described in more detail below with respect to FIG. 9B.

The fourth sample and hold circuit SH4 includes a fourth input switch SW4in, a fourth capacitor C4, and a fourth output switch SW4out. The fourth input switch SW4in is coupled (e.g., on an input side) to the detector portion 140 (e.g., to a second detector of the detector portion 140) and is coupled (e.g., on an output side) to the fourth capacitor C4. The fourth output switch SW4out is coupled (e.g., on an input side) to the fourth capacitor C4, and is coupled (e.g., on an output side) to the analog to digital converter 152. The operations of the sample and hold portion SHP′″ (e.g., including control of the switches SW4in and SW4out by control signals Trig4in and Trig4out, respectively) will be described in more detail below with respect to FIG. 9B.

FIG. 9B illustrates certain signals in relation to the operations of the sample and hold portion SHP′″ of FIG. 9A. FIG. 9B shows signals versus time, for a laser frequency, control signals Trig1in, Trig1out, Trig2in, Trig2out, Trig3in, Trig3out, Trig4in and Trig4out and a representative combined signal for Combined Trigouts (i.e., including Trig1out+Trig2out+Trig3out+Trig4out). The control signals Trig1in, Trig1out, Trig2in and Trig2out have certain similarities to the control signals as described above with respect to FIG. 7B, and will be understood to have analogous functions, except as otherwise described below.

The laser frequency as shown in FIG. 9B is the same as and will be understood in accordance with the description of the laser frequency of FIG. 7B. As will be described in more detail below, the analog to digital conversions (e.g., the digitizing of the signals) are interlaced between the first, second, third and fourth sample and hold circuits SH1, SH2, SH3 and SH4. The control signals Trig1in, Trig1out, Trig2in, Trig2out, Trig3in, Trig3out, Trig4in and Trig4out are utilized for controlling the switches SW1in, SW1out, SW2in, SW2out, SW3in, SW3out, SW4in and SW4out, respectively, of the sample and hold portion SHP′″. The first and second input control signals Trig1in and Trig2in are shown to be provided according to a first sample rate SR1 for operating the first and second input switches SW1in and SW2in. The third and fourth input control signals Trig3in and Trig4in are shown to be provided according to a second sample rate SR2 for operating the third and fourth input switches SW3in and SW4in. The second sample rate SR2 is noted to be lower than the first sample rate SR1, as will be described in more detail below.

With respect to the more specific operations of the first and second sample and hold circuits SH1 and SH2 as described above with respect to FIG. 7B, it will be appreciated that similar operations may be performed with respect to the first and second, and third and fourth, sample and hold circuit of FIG. 9B. As a brief summary, the switches SW1in and SW1out may be controlled, in accordance with the control signals Trig1in and Trig1out, to store samples on the capacitor C1, and then provide the samples to be digitized by the analog to digital converter 152. In accordance with this process (i.e., in accordance with the indicated transitions of the control signals Trig1in and Trig1out), the signal from the detector portion 140 (e.g., the combined light electrical signal from a first detector) as sampled by the first sample and hold circuit SH1 may be digitized by the analog to digital converter 152.

The switches SW2in and SW2out may be controlled, in accordance with the control signals Trig2in and Trig2out, to store samples on the capacitor C2, and then provide the samples to be digitized by the analog to digital converter 152. In accordance with this process (i.e., in accordance with the indicated transitions of the control signals Trig2in and Trig2out), the signal from the detector portion 140 (e.g., the combined light electrical signal from a second detector) as sampled by the second sample and hold circuit SH2 may be digitized by the analog to digital converter 152.

The switches SW3in and SW3out may be controlled, in accordance with the control signals Trig3in and Trig3out, to store samples on the capacitor C3, and then provide the samples to be digitized by the analog to digital converter 152. In accordance with this process (i.e., in accordance with the indicated transitions of the control signals Trig3in and Trig3out), the signal from the detector portion 140 (e.g., the combined light electrical signal from a first detector) as sampled by the third sample and hold circuit SH3 may be digitized by the analog to digital converter 152.

The switches SW4in and SW4out may be controlled, in accordance with the control signals Trig4in and Trig4out, to store samples on the capacitor C4, and then provide the samples to be digitized by the analog to digital converter 152. In accordance with this process (i.e., in accordance with the indicated transitions of the control signals Trig4in and Trig4out), the signal from the detector portion 140 (e.g., the combined light electrical signal from a second detector) as sampled by the fourth sample and hold circuit SH4 may be digitized by the analog to digital converter 152.

As noted above, the second sample rate SR2 is lower than the first sample rate SR1. In the specific example of FIG. 9B, for the time period that is illustrated, in accordance with the first sample rate SR1, there are shown to be 29 cycles of the first and second input control signals Trig1in and Trig2in (e.g., corresponding to 29 instances of the first and second input control signals Trig1in and Trig2in cycling from low to high, and from high to low). In accordance with the second sample rate SR2, there are shown to be 28 cycles of the third and fourth input control signals Trig3in and Trig4in (e.g., corresponding to 28 instances of the third and fourth input control signals Trig3in and Trig4in cycling from low to high, and from high to low). As a specific numerical example, this may indicate a ratio of SR2/SR1=28/29=0.97. Some design considerations for having the relatively small differences between the first and second sample rates will be described in more detail below following the description of FIG. 9B.

As shown at the bottom of FIG. 9B, the analog to digital converter sample rate SRADC corresponds to the combination of the first, second, third and fourth output control signals Trig1out, Trig2out, Trig3out and Trig4out. In the illustrated example, the analog to digital converter sample rate is noted to be approximately 4× the first sample rate SR1. The timings of the first, second, third and fourth output control signals Trig1out, Trig2out, Trig3out and Trig4out are structured so that the analog to digital converter sample rate SRADC desirably occurs with samples at regularly spaced intervals (e.g., thus reducing the requirements on the analog to digital converter). It is noted that this occurs even though a similar combination of the first, second, third and fourth input control signals Trig1in, Trig2in, Trig3in and Trig4in would not be so structured, and would have varying spacings between the combination of control signals, including some intervals where the spacings would be very small, as could create significant processing burdens without the current circuit structure as illustrated and described herein.

In the present example, the desirable effect is achieved in part by having the third and fourth output control signals Trig3out and Trig4out structured to provide the regularly spaced contribution to the analog to digital converter sample rate SRADC, but not structured to exactly match the timings of the corresponding third and fourth input control signals Trig3in and Trig4in. For example, as contrasted with the first and second output control signal Trig1out and Trig2out which are each shown to provide a transition shortly after each transition of the respective first and second input control signals Trig1in and Trig2in (e.g., as illustrated in part by some small example arrows between Trig2in and Trig2out indicating the sample and conversion timing relationships), the transitions of the third output control signal Trig3out occur at different spacings after the transitions of the third input control signal Trig3in (e.g., as illustrated in part by some small example arrows between Trig3in and Trig3out indicating the sample and conversion timing relationships). Similarly, the transitions of the fourth output control signal Trig4out occur at different spacings after the transitions of the fourth input control signal Trig4in (e.g., as illustrated in part by some small example arrows between Trig4in and Trig4out indicating the sample and conversion timing relationships). In certain implementations, this may occasionally result in a skipped analog to digital conversion, as illustrated in FIG. 9B by empty boxes MK in the illustrated transitions for the third or fourth output control signals Trig3out or Trig4out, and correspondingly in the Combined Trigouts (i.e., the combined Trig1out+Trig2out+Trig3out+Trig4out). In various implementations, this may also be characterized as corresponding to duplicate samples due to a Vernier effect between the sample rates.

As noted above, the output control signals Trig1out, Trig2out, Trig3out and Trig4out (e.g., as corresponding to the providing of the samples to the analog to digital converter 152) are structured so as to reduce the requirements on the analog to digital converter. As can be seen, the output signals to the analog to digital converter 152 (i.e., as indicated by the analog to digital converter sample rate SRADC at the bottom of FIG. 9B) are structured to be at specified intervals (i.e., with specified regular spacings between the transitions/samples), which reduces the requirements for the analog to digital converter. This may be contrasted to a configuration in which the sample and hold circuits were not present, and if the analog to digital converter was tasked with acquiring the data by itself (e.g., for which there would not be regular spacings for the signals and some of the acquisition signals/timings between the sample rates would be very close to one another, which would significantly increase the operating requirements for the analog to digital converter). In addition, a quadrature processing (e.g., with the simultaneous inputs for the input control signals Trig1in and Trig2in, and the simultaneous inputs for the input control signals Trig3in and Trig4in) in various implementations may generally not be achieved with a single analog to digital converter, if the sample and hold circuits as illustrated and described herein were not present. It will be appreciated that certain advantages may be associated with a configuration utilizing a single analog to digital converter as compared to multiple analog to digital converters (e.g., potential reduced expense and/or size of the configuration, potential improved accuracy due to the use of a single converter for digitizing the signals as opposed to multiple converters which may have slightly different characteristics that may affect the converted signals differently and/or may result in other differences, etc.)

In regard to the configurations of FIGS. 7A, 7B, 8A, 8B, 9A and 9B, in various implementations, the relatively small differences between the sample rates (e.g., between the first and second sample rates in FIGS. 7B and 9B, or between the first, second and third sample rates of FIG. 8B, such as in some instances with a differences of less than 10% between the sample rates) may be in accordance with a technique for achieving a longer absolute (ABS) distance range for measurements (e.g., in accordance with having different measurements/measurement scales with slightly different periods/increments). With regard to utilizing an analog to digital converter to digitize the signals related to such slightly different measurement/sample rates, it will be appreciated that a significant burden may otherwise be placed on an analog to digital converter (e.g., if the circuitry as described herein was not provided). For example, due to the slight difference in the rates, there may be periods when some of the measurements/samples are spaced very close together in time, requiring very high/fast operating characteristics (e.g., of an analog to digital converter or otherwise). In accordance with principles as described herein, by utilizing a sample and hold portion, the sample and hold circuits may be utilized for the sampling, and the outputs may be structured so as to reduce the requirements on the analog to digital converter (e.g., as illustrated for the analog to digital converter sample rate SRADC in each of the FIGS. 7B, 8B and 9B).

The configurations of FIGS. 7A, 7B, 8A, 8B, 9A and 9B are noted to have certain advantages over prior systems. As some general principles, in certain prior systems, the Nyquist frequency of an analog to digital converter utilized for digitization of the combined light electrical signal has typically set the maximum beat frequency, and therefore the maximum range that can be measured for a given chirp rate. If frequencies above the Nyquist frequency are sampled by the analog to digital converter, such frequencies may be detected as lower frequencies, in accordance with aliasing. Aliasing may occur because instantaneously sampling a periodic function at two or fewer times per cycle may result in missed cycles, and therefore the appearance of a lower frequency. However, in accordance with principles as described herein, by utilizing multiple measurements (e.g., as performed by different sample and hold circuits) a correct overall beat frequency may be determined, and a corresponding accurate distance determination may be made.

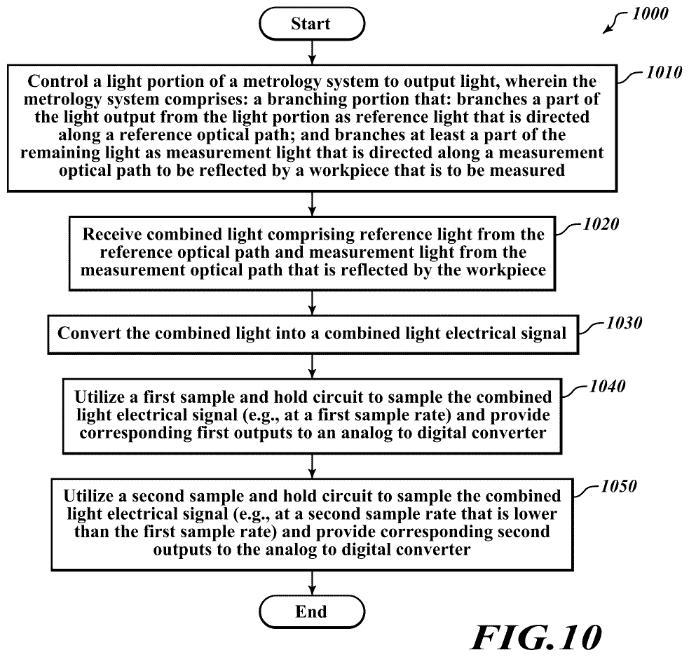

FIG. 10 is a flow diagram illustrating an exemplary implementation of a routine 1000 for operating a metrology system. At a block 1010, a light portion of a metrology system is controlled to output light. The metrology system comprises: a branching portion that: branches a part of the light output from the light portion as reference light that is directed along a reference optical path; and branches at least a part of the remaining light as measurement light that is directed along a measurement optical path to be reflected by a workpiece that is to be measured. At a block 1020, combined light is received (e.g., at a detector portion 140 of a detector and processing portion DPP) comprising reference light from the reference optical path and measurement light from the measurement optical path that is reflected by the workpiece.

At a block 1030, the combined light is converted (e.g., by a detector portion 140) into a combined light electrical signal. At a block 1040, a first sample and hold circuit (e.g., of a sample and hold portion SHP, which may be any of the sample and hold portions SHP′, SHP″, or SHP′″) is utilized to sample the combined light electrical signal (e.g., at a first sample rate) and provide corresponding first outputs to an analog to digital converter. At a block 1050, a second sample and hold circuit (e.g., of the sample and hold portion SHP) is utilized to sample the combined light electrical signal (e.g., at a second sample rate that is lower than the first sample rate) and provide corresponding second outputs to the analog to digital converter.

In various implementations, the method may further include performing a fast Fourier transform for analyzing a digitized signal from the analog to digital converter to determine at least one peak that corresponds to a beat frequency. For example, a processing portion 150 may perform the fast Fourier transform. In various implementations, the samples from each sample and hold portion may be digitized by the analog to digital converter as a digitized signal and a fast Fourier transform may be performed on (i.e., for analyzing) the digitized signal to determine at least one peak that corresponds to a beat frequency. In various implementations, additional processing may be performed to determine a single peak/beat frequency that corresponds to a distance to the workpiece. In various implementations, the method further includes determining a distance to the workpiece based at least in part on a determined peak which corresponds to a beat frequency (e.g., as may be performed by the processing portion 150 or otherwise).

Various embodiments of the metrology system have been disclosed. The following features may be used alone or in any combination with any of the embodiments of the metrology system.

For example, the light that is output by the light portion may comprise laser light for which the oscillation frequency changes linearly over time. As another feature, the reference light may correspondingly comprise laser light for which the oscillation frequency changes linearly over time; and the measurement light may correspondingly comprise laser light for which the oscillation frequency changes linearly over time.

As a further feature, the reference optical path has a reference optical path length; the measurement optical path has a measurement optical path length; and an optical path length difference between the reference optical path length and the measurement optical path length corresponds to a propagation difference and a corresponding propagation delay between the reference light and the measurement light. A beat frequency corresponds to the propagation delay. A processing portion of the detector and processing portion of the metrology system may be configured to determine a distance to the workpiece based at least in part on a determined peak which corresponds to a beat frequency.

While preferred implementations of the present disclosure have been illustrated and described, numerous variations in the illustrated and described arrangements of features and sequences of operations will be apparent to one skilled in the art based on this disclosure. Various alternative forms may be used to implement the principles disclosed herein. In addition, the various implementations described above can be combined to provide further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

What is claimed is:

1. A metrology system, comprising:
a light portion that outputs light;
a branching portion that:
branches a part of the light output from the light portion as reference light that is directed along a reference optical path; and
branches at least a part of the remaining light as measurement light that is directed along a measurement optical path to be reflected by a workpiece that is to be measured; and
a detector and processing portion configured to:
receive combined light comprising reference light from the reference optical path and measurement light from the measurement optical path that is reflected by the workpiece; and
convert the combined light into a combined light electrical signal;
wherein the detector and processing portion comprises:
an analog to digital converter; and
a sample and hold portion comprising at least a first sample and hold circuit and a second sample and hold circuit, wherein the sample and hold portion is coupled to provide outputs to the analog to digital converter.

2. The metrology system of claim 1, wherein the detector and processing portion comprises a detector portion that is configured to detect the combined light and output the corresponding combined light electrical signal, wherein the at least two sample and hold circuits and the analog to digital converter are configured to digitize the combined light electrical signal to produce a digitized signal.

3. The metrology system of claim 2, wherein the detector and processing portion further comprises a processing portion that is configured to perform a fast Fourier transform for analyzing the digitized signal to determine at least one peak that corresponds to a beat frequency.

4. The metrology system of claim 3, wherein the processing portion is configured to determine a distance to the workpiece based at least in part on a determined peak which corresponds to a beat frequency.

5. The metrology system of claim 1, wherein:
the first sample and hold circuit is configured to be operated at a first sample rate; and
the second sample and hold circuit is configured to be operated at a second sample rate that is lower than the first sample rate.

6. The metrology system of claim 1, wherein:
the first sample and hold circuit comprises a first capacitor; and
the second sample and hold circuit comprises a second capacitor.

7. The metrology system of claim 6, wherein:
the first sample and hold circuit comprises a first input switch which is coupled to the first capacitor; and
the second sample and hold circuit comprises a second input switch which is coupled to the second capacitor.

8. The metrology system of claim 7, wherein:
the first input switch is operated according to a first sample rate; and
the second input switch is operated according to a second sample rate that is lower than the first sample rate.

9. The metrology system of claim 7, wherein:
the first sample and hold circuit comprises a first output switch which is coupled to the first capacitor, wherein the first output switch is configured to be operated to couple the first capacitor to the analog to digital converter; and
the second sample and hold circuit comprises a second output switch which is coupled to the second capacitor, wherein the second output switch is configured to be operated to couple the second capacitor to the analog to digital converter.

10. The metrology system of claim 1, wherein at least one of the reference optical path or the measurement optical path comprises a dispersion portion, wherein an imbalanced dispersion between the reference optical path and the measurement optical path results at least in part from the dispersion portion.

11. The metrology system of claim 1, wherein the sample and hold portion further comprises a third sample and hold circuit.

12. The metrology system of claim 11, wherein:
the first sample and hold circuit is configured to be operated at a first sample rate;
the second sample and hold circuit is configured to be operated at a second sample rate that is lower than the first sample rate; and
the third sample and hold circuit is configured to be operated at a third sample rate that is lower than the second sample rate.

13. The metrology system of claim 11, wherein the sample and hold portion further comprises a fourth sample and hold circuit.

14. The metrology system of claim 13, wherein:
the sample and hold portion is configured to be operated for quadrature processing;
the first and second sample and hold circuits are configured to be operated at a first sample rate; and
the third and fourth sample and hold circuits are configured to be operated at a second sample rate that is lower than the first sample rate.

15. The metrology system of claim 1, further comprising a combining portion that receives and combines reference light from the reference optical path and measurement light from the measurement optical path, wherein the detector and processing portion receives the combined light from the combining portion.

16. The metrology system of claim 1, wherein the light that is output by the light portion comprises laser light for which an oscillation frequency changes linearly over time.

17. A method for operating a metrology system,
the metrology system comprising:
a light portion that outputs light; and
a branching portion that:
branches a part of the light output from the light portion as reference light that is directed along a reference optical path; and
branches at least a part of the remaining light as measurement light that is directed along a measurement optical path to be reflected by a workpiece that is to be measured;
the method comprising:
receiving combined light comprising reference light from the reference optical path and measurement light from the measurement optical path that is reflected by the workpiece;
converting the combined light into a combined light electrical signal;
utilizing a first sample and hold circuit to sample the combined light electrical signal at a first sample rate and provide corresponding first outputs to an analog to digital converter; and
utilizing a second sample and hold circuit to sample the combined light electrical signal at a second sample rate that is lower than the first sample rate and provide corresponding second outputs to the analog to digital converter.

18. The method of claim 17, further comprising performing a fast Fourier transform for analyzing a digitized signal from the analog to digital converter to determine at least one peak that corresponds to a beat frequency.

19. The method of claim 18, further comprising determining a distance to the workpiece based at least in part on a determined peak which corresponds to a beat frequency.

20. A metrology system, comprising:
a light portion that outputs light;
a branching portion that:
branches a part of the light output from the light portion as reference light that is directed along a reference optical path; and
branches at least a part of the remaining light as measurement light that is directed along a measurement optical path to be reflected by a workpiece that is to be measured; and
a detector and processing portion comprising:
an analog to digital converter; and
a sample and hold portion comprising at least a first sample and hold circuit and a second sample and hold circuit, wherein the sample and hold portion is coupled to provide outputs to the analog to digital converter;
wherein the metrology system is configured to:
receive combined light comprising reference light from the reference optical path and measurement light from the measurement optical path that is reflected by the workpiece;
convert the combined light into a combined light electrical signal;
utilize the first sample and hold circuit to sample the combined light electrical signal at a first sample rate and provide corresponding first outputs to the analog to digital converter; and
utilize the second sample and hold circuit to sample the combined light electrical signal at a second sample rate that is lower than the first sample rate and provide corresponding second outputs to the analog to digital converter.
